(19) United States
(12) Patent Application Publication
(10) Pub. No.: US 2009/0207562 A1
(43) Pub. Date: Aug. 20, 2009

(54) DISPLAY DEVICE AND HOLDER THEREOF

(76) Inventors: Deng-Siang YANG, Taipei City (TW); Sheng-Hong WANG, Teipei City (TW)

Correspondence Address: Muncy, Geissler, Olds & Lowe, PLLC, P.O. BOX 1364, FAIRFAX, VA, 22038-1364, US

(21) Appl. No.: 12/354,199

(22) Filed: Jan. 15, 2009

(30) Foreign Application Priority Data
Feb. 14, 2008 (TW) 097105161

(51) Int. Cl. G06F 1/16

(52) U.S. Cl. 361/679.21

(57) ABSTRACT

A holder for fixing a display module to the casing of a display device is disclosed. The holder includes a bent portion and an elastic arm. The bent portion is fixed to the casing. The elastic arm is connected to the bent portion. The elastic arm is fixed to the side of the display module. A display device using the holder is also disclosed.

### CROSS REFERENCE TO RELATED APPLICATIONS

This Non-provisional application claims priority under 35 U.S.C. §119(a) on Patent Application No(s). 097105161 filed in Taiwan, Republic of China on Feb. 14, 2008, the entire contents of which are hereby incorporated by reference.

### BACKGROUND OF THE INVENTION

1. Field of Invention

The invention relates to a holder and, more particularly, to a holder for fixing a display module and a display device using the same.

2. Related Art

An electronic device in the market is not only manufactured by one manufacturer, and it is manufactured via the cooperation of upstream manufacturers and downstream manufacturers. The electronic device is, for example, a display device. The upstream manufacturers manufacture various kinds of components, and the components are then sent to system manufacturers to be assembled. To the system manufacturers, if the number of the assembling steps is reduced, then the production cost is reduced and the production efficiency increases.

A liquid crystal display device is taken as an example to illustrate the component and assembling flow path of the display device. The liquid crystal display device mainly includes a front lid, a liquid crystal display module, two holders and a back casing. The front lid, the back casing, the holder and the liquid crystal display module are manufactured by different manufacturers, respectively, and then they are assembled to be a liquid crystal display device by a system manufacturer. The assembling steps of the display device are described hereinbelow. First, the two holders are locked to the two corresponding sides of the liquid crystal display module, respectively. Then, the liquid crystal display module and the holder are disposed at the back casing. Afterward, the holder at the side is locked to the back casing. At last, the front lid is locked to the back casing.

Since the front lid, the liquid crystal display module and two holders are assembled by the system manufacturer, if the assembling process is complex, a lot of assembly time is cost, and the production cost increases. In addition, the two holders at the sides are locked to the two corresponding sides of the liquid crystal display module. After that, when the liquid crystal display module is locked to screwed holes on the back casing, if the screwed holes at the liquid crystal display module and the screwed holes at the back casing are hard to be corresponding to each other because of the tolerance, the screwed holes on the back casing should be manufactured to have a big margin in the tolerance direction, and even an elliptical screwed hole is formed. Thus, a problem that the structure is not compact after the back casing is locked to the liquid crystal display device arises. The problem obsesses the system the manufacturer greatly.

### SUMMARY OF THE INVENTION

The invention provides a display device and a holder which can reduce assembly time and cost for system manufacturers and solve problems of assembly tolerance when the display device is assembled.

A holder in the invention is used for fixing a display module to the casing of a display device. The holder includes a bent portion and an elastic arm. The bent portion is fixed to the casing. The elastic arm is connected to the bent portion. The elastic arm is fixed to the side of the display module.

A display device in the invention includes a casing, a display module, a holder and a locking element. The display module is disposed at the casing. The holder has a bent portion and an elastic arm. The bent portion is fixed to the casing, and the elastic arm is connected to the bent portion and has a through hole. The locking element passes through the through hole and locks the elastic arm to the side of the display module.

Since the holder in the invention has an elastic arm, when the locking element passes through the through hole on the elastic arm to lock the elastic arm to the display module, the elastic arm is deformed to prop against the display module and to compensate for the tolerance between the display module and the holder. Thus, the assembly closeness of the display device increases. In addition, in the display device of the invention, the holder and the casing may be assembled by manufacturers, and then they are sent to system manufacturers to make the display module and the holder assembled. Thus, the assembly cost and the production time of the system manufacturers are reduced.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a display device in a preferable embodiment of the invention;

FIG. 2A and FIG. 2B are schematic diagrams showing holders in a preferable embodiment of the invention; and

FIG. 3A and FIG. 3B are schematic diagrams showing a display device before a holder is locked to the display device and after the holder is locked to the display device in a preferable embodiment of the invention, respectively.

### DETAILED DESCRIPTION OF THE INVENTION

These and other features, aspects and advantages of the present invention will become better understood with regard to the following description, appended claims, and accompanying drawings.

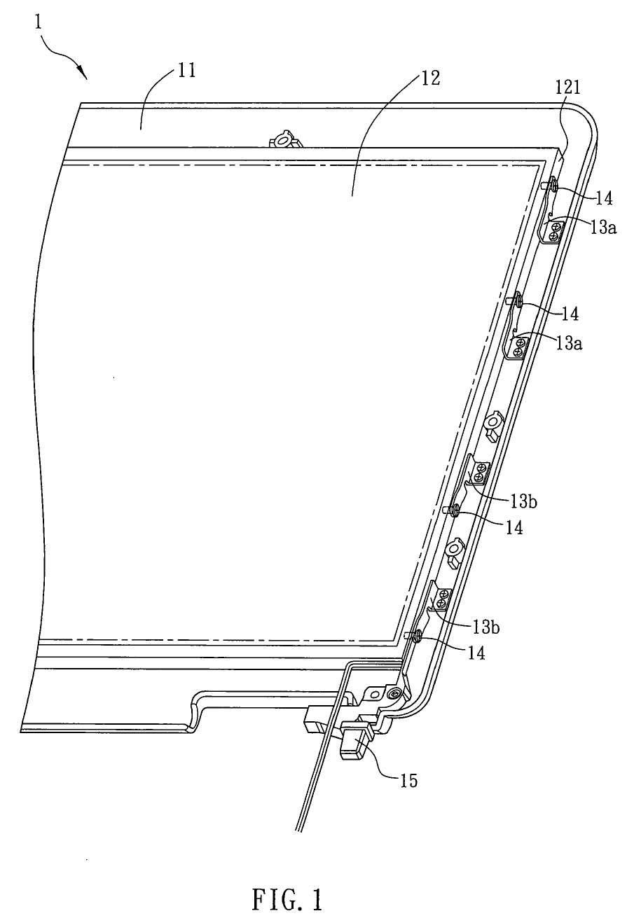

As shown in FIG. 1, a display device 1 in a preferable embodiment of the invention includes a casing 11, a display module 12, multiple holders 13a and 13b and multiple locking elements 14. The display device 1 in the embodiment is, for example, a liquid crystal display device, but it is not used to limit the scope of the invention. The display device 1 also may be a plasma display device, an organic electroluminescense display device or a field emission display device and so on.

The casing 11 is a back casing of the display device 1, that is, the casing at the back of the display module 12. The display module 12 is disposed at the casing 11. The holders 13a and 13b are used to fix the display module 12 to the sides of the casing 11.

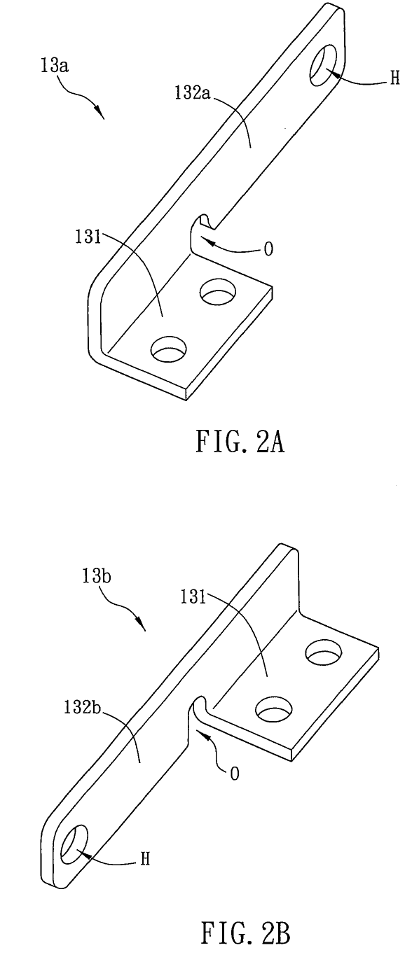

As shown in FIG. 1 and FIG. 2A, the holder 13a has a bent portion 131 and an elastic arm 132a. The bent portion 131 in the embodiment is L-shaped. The bent portion 131 may be combined with the casing 11 in a fastening, sticking, riveting or locking mode. In the embodiment, a locking mode is taken as an example. Every bent portion 131 has two screwed holes to allow the locking element to pass through and lock the bent portion 131 and the casing 11.

The elastic arm 132a is connected to the bent portion 131 in a fastening, sticking, riveting, locking or an integral forming mode. The integral forming mode herein is taken as an example. In the manufacturing process, the holder 13 is integrally formed by alloy or metal. In the embodiment, an indentation space O is formed between the elastic arm 132a and the bent portion 131 to reduce the connecting area of the elastic arm 132a and the bent portion 131. Thus, flexibility and deformation ability of the elastic arm 132a increase. The material of the elastic arm 132a has flexibility, and it may be metal or alloy. The elastic arm 132a has a through hole H. The locking element 14 passes through the through hole H and locks the elastic arm 132a to the side 121 of the display module 12. The display module 12 also has holes corresponding to the through hole H to allow the locking element 14 to pass through.

In addition, FIG. 2B shows another holder 13b in the embodiment of the invention. The difference between the holder 13a and 13b is that the elastic arm 132a of the holder 13a extends from the first end of the bent portion 131, while the elastic arm 132b of the holder 13b extends from the second end of the bent portion 131. The holder in the invention also may have two elastic arms 132a and 132b extending from the first end and the second end of the bent portion 131, respectively.

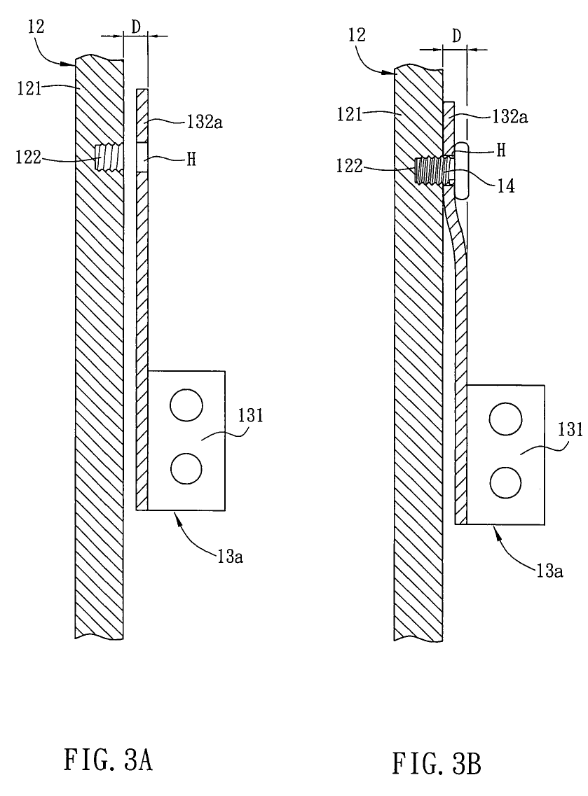

FIG. 3A and FIG. 3B are schematic diagrams showing the display module 12 before the holder 13a is locked to the display module 12 and after the holder 13a is locked to the display module 12, respectively. As shown in FIG. 3A and FIG. 3B, before the locking element 14 passes through the through hole H and the hole 122 of the display module 12, a tolerance D exists between the display module 12 and the bent portion 131 of the holder 13a. After the elastic arm 132a is locked to the side 121 of the display module 12 by the locking element 14, the elastic arm 132a is deformed and props against the side 121 of the display module 12 to compensate for the tolerance D between the holder 13a and the display module 12. Thus, the assembly closeness of the holder 13b and the display module 12 increases. Since the holder 13b has the same technology feature with that of the holder 13a, it is not described for concise purpose.

In the invention, besides the embodiment above, the holder also may have multiple aspects. The shape of the holder in the invention is not limited. For example, in the embodiment above, four holders 13a and 13b are taken as an example. However, the four holders also may be combined to be one holder. The number of the through holes H on the elastic arms 132a and 132b are not limited. The elastic arms 132a and 132b may have multiple through holes. The number of the locking elements 14 and the holes of the display module 12 should increase correspondingly.

As shown in FIG. 1, the display device 1 (such as a liquid crystal display device) may have a pivot structure 15. The pivot structure 15 may be connected to the holder 13b. Thus, the pivot structure 15 may be connected to the body of an electronic device. In addition, another frame (such as the frame of the display device) may be combined with the casing 11. Thus, the assembly of the display device I is finished.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A holder for fixing a display module to the casing of a display device, the holder comprising:
a bent portion fixed to the casing; and
an elastic arm connected to the bent portion, wherein the elastic arm is fixed to the side of the display module.

2. The holder according to claim 1, wherein the bent portion and the elastic arm are connected to each other in a fastening mode, a sticking mode, a riveting mode, a locking mode or an integral forming mode.

3. The holder according to claim 1, wherein the bent portion and the casing are connected to each other in a fastening mode, a sticking mode, a riveting mode or a locking mode.

4. The holder according to claim 1, wherein the bent portion is L-shaped.

5. The holder according to claim 1, wherein an indentation space is formed between the bent portion and the elastic arm.

6. The holder according to claim 1, wherein the elastic arm has flexibility.

7. The bolder according to claim 1, wherein the elastic arm is made of metal or alloy.

8. The holder according to claim 1, wherein the display module has a hole and elastic arm has a through hole, the elastic arm is fixed to the display module by a locking element passing through the hole and the through hole.

9. A display device comprising:
a casing;
a display module disposed at the casing;
a holder having a bent portion and an elastic arm, wherein the bent portion is fixed to the casing, and the elastic arm is connected to the bent portion and has a through hole; and
a locking element passing through the through hole and locking the elastic arm to the side of the display module.

10. The display device according to claim 9, wherein the bent portion and the elastic arm are connected to each other in a fastening mode, a sticking mode, a riveting mode, a locking mode or an integral forming mode.

11. The display device according to claim 9, wherein the bent portion and the casing are connected to each other in a fastening mode, a sticking mode, a riveting mode or a locking mode.

12. The display device according to claim 9, wherein the bent portion is L-shaped.

13. The display device according to claim 9, wherein an indentation space is formed between the bent portion and the elastic arm.

14. The display device according to claim 9, wherein the elastic arm has flexibility.

15. The display device according to claim 9, wherein the elastic arm is made of metal or alloy.

16. The display device according to claim 9, further comprising a pivot structure connected to the end of the holder.
